(19) United States
(12) Patent Application Publication
(10) Pub. No.: US 2008/0098000 A1
(43) Pub. Date: Apr. 24, 2008

(54) System and method for storing user data in a centralized database and intelligently reducing data entry

(75) Inventors: David A. Koretz, Rochester, NY (US); Rob Chamberlin, Webster, NY (US); James Simpson, Rochester, NY (US); Stephen Wong, Rochester, NY (US)

Correspondence Address: NIXON PEABODY LLP - PATENT GROUP, 1100 CLINTON SQUARE, ROCHESTER, NY, 14604, US

(73) Assignee: Blue Tie, Inc., Pittsford, NY (US)

(21) Appl. No.: 11/584,640

(22) Filed: Oct. 23, 2006

(51) Int. Cl. G06F 17/30

(52) U.S. Cl. 707/10

(57) ABSTRACT

A method and system for storing user-specific information in a centralized database and reducing data entry by intelligently determining what data is already stored in the centralized database and what data needs to be collected from the user. The method includes receiving a request from a user of a user computing system to initiate a transaction, wherein the transaction requires user-specific information in at least one associated field to complete the transaction, and receiving a request from a service provider system for the user-specific information. The method further includes providing the service provider system with the user-specific information when the user-specific information is stored in the centralized database, and, when the user-specific information is not stored in the centralized database, requesting the user-specific information from the user computing system, receiving the user-specific information from the user computing system, and storing the user-specific information received from user computing system in the centralized database.

### FIELD OF THE INVENTION

This invention generally relates to data storage methods and processes, and more particularly, to a system and method for storing user-specific information in a centralized database and intelligently reducing data entry.

### BACKGROUND

Nearly all eCommerce websites and Internet-based applications store their own copy of their customers' data. This is done to expedite future purchases or usage. From a customer perspective, however, this has many disadvantages. First, customers must have many copies of their personal data stored on various servers on the Internet. In addition, every time they want to make a purchase with a new vendor they must manually re-enter all of their data.

Various systems such as Microsoft Passport, Google's gBuy, and Yahoo! Wallet exist to store credit card, billing, and shipping data in either a secure desktop client or a Web-based centralized storage model. All of these systems are designed for consumers, and have been slow to catch on due to security concerns by customers (http://news.com.com/2100-1017-955420.html). In addition, these services were designed for product sales where all of the required fields are nearly identical. These systems do not work well in services models where there is a high variation of data required between the disparate online services such as credit card application, online fax subscription, email marketing services, and office supply purchases.

In addition, U.S. Pat. No. 7,016,875 discloses a simple centralized database, in which users are required to manually enter data in a centralized location. This patent has several weaknesses because it does not account for services where a wide variety of data may be required; it is limited in use to transactions that use a substantially similar dataset. This patent also does not have a method for enabling service providers to easily use their existing data storage formats and requires the service provider to conform to a different data model. The patent is further limited because it does not have an automated means to collect datasets and to only query the user for needed data elements that are not already stored in the central data store.

Thus, there exists a need for a centralized storage system for user-specific information that increases the efficiency of eCommerce transactions by reducing the amount of data that needs to be entered by a user, making it more likely that they will complete the transaction.

### SUMMARY

The present invention answers this need by providing a method for storing user-specific information in a centralized database and reducing data entry by intelligently determining what data is already stored in the centralized database and what data needs to be collected from the user. The method includes receiving a request from a user of a user computing system to initiate a transaction, wherein the transaction requires user-specific information in at least one associated field to complete the transaction, and receiving a request from a service provider system for the user-specific information. In addition, the method includes providing the service provider system with the user-specific information when the user-specific information is stored in the centralized database, requesting the user-specific information from the user computing system when the user-specific information is not stored in the centralized database, and receiving the user-specific information from the user computing system when the user-specific information is not stored in the centralized database. Furthermore, the method includes storing the user-specific information received from user computing system in the centralized database when the user-specific information is not stored in the centralized database.

The method may further include a step of identifying the user-specific information required for the transaction. Also, a user may provide the user-specific information not stored in the centralized database via the user computing system. Furthermore, the user-specific information sent to the service provider system may be limited to only the user-specific information needed to complete the current transaction, and the user may be notified that user-specific information data is being transferred to the service provider system to protect their privacy and data security. In addition, the centralized database may be published to a central server on a network after the user-specific information is received from the user computing system and stored in the centralized database.

In addition, a master list of all fields stored in the centralized database may be utilized. In this case, the service provider system may map all existing fields to the master list. The master list may also be in a standardized format, for example, XML. In addition, the service provider system may complete the transaction without receiving any user-specific information from the user computing system when all of the needed user-specific information is already stored in the centralized database. In this case, the transaction may be completed without providing any of the user-specific information to the user computing system. Moreover, a user of the user computing system may choose to have the transaction be completed without receiving any user-specific information from the service provider system when all of the needed user-specific information is already stored in the centralized database.

The methods of the present invention may also be embodied on a computer readable medium. In this case, the computer readable medium has instructions stored thereon for storing user-specific information in a centralized database comprising machine executable code which when executed by at least one processor, causes the processor to perform the methods of the invention.

The present invention further relates to a system for storing user-specific information in a centralized database. The system includes a user computing system operable to initiate a transaction, wherein the transaction requires user-specific information in at least one associated field to complete the transaction. The system further includes an application provider system comprising a centralized database operable to store user-specific information associated with at least one field. In addition, the system includes a service provider system operable to request user-specific information from the application provider system. The application provider system provides the user-specific information to the service provider system when the user-specific information is stored in the centralized database of the application provider system. Similarly, the application provider system requests the user-specific information from the user computing system when the user-specific information is not stored in the centralized database, and receives the user-specific information from the user computing system when the user-specific information is not stored in the centralized database. In this case, the application provider system stores the user-specific information in the centralized database when the user-specific information is not stored in the centralized database.

In addition, the user-specific information required for the transaction may be identified. Also, a user may provide the user-specific information not stored in the centralized database via the user computing system. Furthermore, the user-specific information sent to the service provider system may be limited to only the user-specific information needed to complete the current transaction. In this case, a user may be notified that user-specific information data is being transferred to the service provider system to protect their privacy and data security. In addition, the centralized database may be published to a central server on a network after the user-specific information is received from the user computing system and stored in the centralized database.

The system may further include a master list of all fields stored in the centralized database. The service provider system may be operable to map all existing fields to the master list. In addition, the master list may be in a standardized format, for example, XML. Furthermore, the service provider system may complete the transaction without receiving any user-specific information from the user computing system when all of the needed user-specific information is already stored in the centralized database. In this case, the transaction may be completed without providing any of the user-specific information to the user computing system. In addition, a user of the user computing system may choose to have the transaction completed without receiving any user-specific information from the service provider system when all of the needed user-specific information is already stored in the centralized database.

Thus, the present invention provides systems and methods for utilizing a centralized database on a computing network to gather user data in the course of normal application usage and the execution of user-initiated purchasing or using transactions. As the user-specific information is gathered, the information is populated to data fields (i.e. a master field list), stored within a centralized database (i.e. a Central Data Store), and shared among a plurality of service providers. The user data, or user-specific information, is stored within the centralized database (i.e. a Central Data Store) in a universal format (e.g. XML), and data necessary to complete a transaction is sent to service providers while the transaction is being completed.

The present invention overcomes the limitations of U.S. Pat. No. 7,016,875 by collecting data that is entered by a user as they complete transactions and usage by matching fields in the master field list and adding the data to the master profile. Additionally, the present invention does not require a service provider system to conform to a new data specification. The present invention lets the service provider system map its existing data fields and data structure to the master field list. This dramatically reduces implementation time and complexity.

Because the user-specific data is stored in a centralized database, the amount of entry required by each user during the course of a transaction is dramatically reduced. For example, as a new transaction is initiated, a user is only prompted to provide data necessary to complete the current transaction which has not been provided in the past. In particular, the user is not required to provide any data that has previously been provided since the centralized database would automatically provide the relevant prior user-specific information. In this manner, users are only required to input user-specific data once during a transaction and have it re-used multiple times over any number of future transactions.

For example, when booking a flight, the service provider (i.e. the travel agent) may require a user to provide numerous pieces of user data such as name, address, phone number, and frequent flyer number. If the centralized database already includes the user's profile, and the profile includes the user's name, address, and phone number, the user would only be required to input his or her frequent flyer number, as the rest of the information would be automatically provided to the service provider by the centralized database. As another example, if a user was making a dinner reservation, which requires name and telephone information, and the centralized database already had the user's telephone number stored, the user would only be required to provide his or her name. The centralized database may also include other fields in the user's profile, including, for example, club memberships, smoking/non-smoking preferences, etc. This information may be populated to the restaurant's reservation for as well, if requested. Thus, the present invention eliminates the need to navigate through multiple websites and applications and reduces the amount of data entry required by a user to use various disparate services. In addition, the system protects the user's privacy by limiting the data sent to each partner, as information is only sent to the service provider if it is requested to complete a transaction.

In addition, contrary to many traditional online wallet systems, the present invention does not require a user to enter data and then subsequently find a merchant that accepts that payment model. Instead, data is collected during the course of each transaction the user performs so additional user-specific data is constantly being gathered and stored. The user is only prompted to enter the data that is not already stored when they decide to complete a transaction. This means the purchase is the impetus to adding data, which overcomes the current problem of user's not seeing value in the wallet because they are not at the point where they are looking to complete a transaction.

As indicated above, the shared data of the centralized database reduces the amount of data entry required by users when completing transactions. During each user initiated transaction the application provider system will query the service provider system for a list of required fields to complete the transaction. If new fields are required (for which data has not been previously entered by the user), the user will be prompted to fill in the fields. The requisite data is then transferred by the user computing system to the application provider system where it is stored and then sent on to the service provider system to complete the transaction.

The centralized database is preferably organized into a plurality of data fields for storage of user-specific information. These fields are complied into a master field list, which is a comprehensive list of all fields required for all supported transactions and services. Each field is associated with a transactional field for at least one of a transaction and service from a service provider system. These fields may include, for example, contact information (e.g. address information, telephone/facsimile number, email addresses, etc.), financial information (e.g. bank account information, credit card information, investments, etc.), personal information (e.g. insurance information, medical history, etc.), and the like. Each time a user initiates a transaction, the system matches the transactional fields needed to complete the transaction to existing fields in the centralized database. All fields that have previously been entered for the requesting user are automatically populated into a form accessible by the user on the device he/she is using to complete the transaction. The user computing system may be any type of computing device including, but not limited to, a computer, a mobile computing device (e.g. a PDA, cellular phone, Blackberry, etc.), and the like.

In this manner, the user will only be required to input information which was not stored in the centralized database. In addition, the user may choose to revise some of the existing information provided by the centralized database. For example, the user may be shown the data that is available in the centralized database related to the current transaction, and may revise some or all of the data if needed. Once the user completes the transaction form, any new or revised fields including user-specific information are transferred to the application provider system and stored in the centralized database and stored in the user profile associated with that user. This process simplifies future transactions by reducing the amount of repeat information needed from a user during a transaction.

The centralized database of the invention also preferably stores the user-specific information in a universal format that can be processed by virtually any service provider system. In particular, it is preferred that the user-specific information be stored in a standards-based format, such as XML, which enables any service provider system to compare their own respective fields with the fields in the centralized database. In this way, it is not necessary for each service provider that wishes to utilize the system of the invention to modify their storage preferences and/or data models in any way. Instead, each service provider merely needs to create a linkage (i.e. a Transaction Conduit) between the fields required for their specific transactions and the fields contained within the centralized database.

### BRIEF DESCRIPTION OF THE DRAWINGS

FIG. 1 is an illustration of an exemplary system of the invention that is used to store data in a centralized location.

FIG. 2 is a flow chart describing an exemplary method of the invention related to a centralized database.

FIG. 3 is a flow chart describing an exemplary method of the invention related to a transaction carried out within the system of the invention.

### DETAILED DESCRIPTION OF THE INVENTION

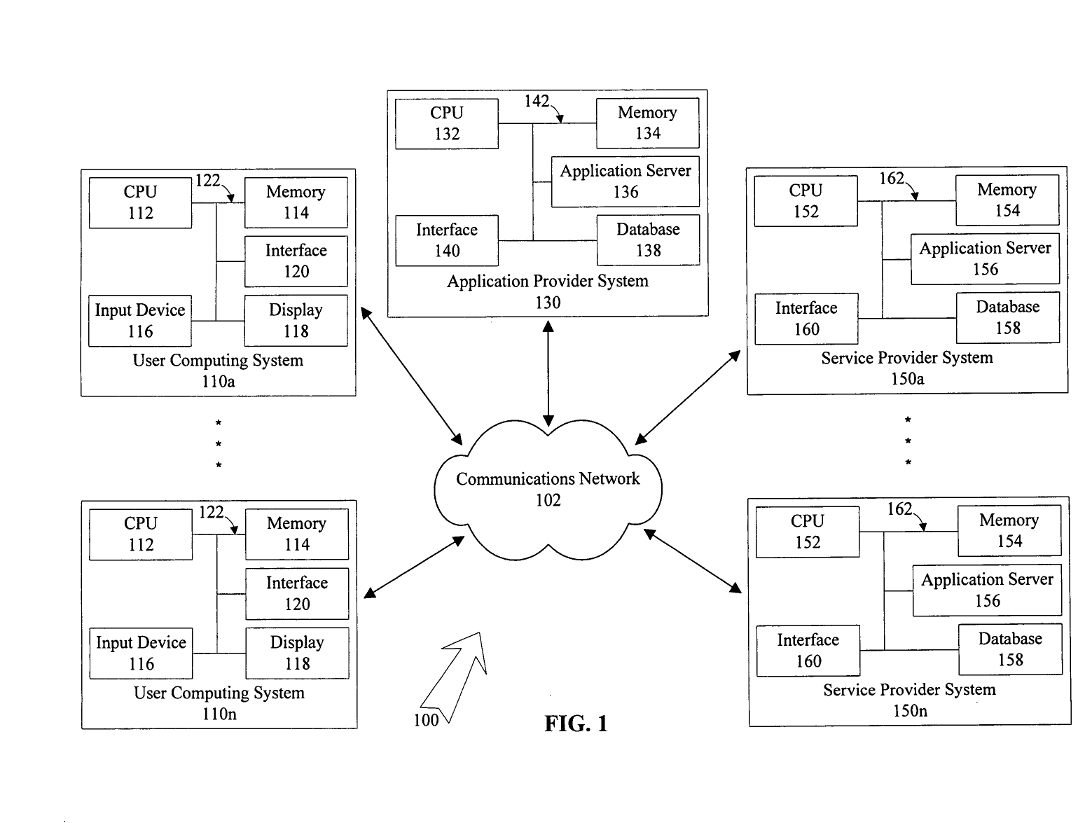

Referring now to the figures, FIG. 1 is an illustration of an exemplary system of the invention that is used to store data in a centralized location, specifically, in database 138. As is shown in FIG. 1, system 100 includes an application provider system 130, user computing systems 110a-110n, service provider systems 150a-150n, and a communications network 102. While an exemplary system of the invention includes the above components, system 100 can include any other numbers and types of server systems, systems, devices, equipment, and/or components in other configurations. The present invention provides a number of advantages including providing an effective and automatic method for users of a Web-based or client-server software application to complete relevant transactions with minimal data entry.

Referring more specifically to FIG. 1, application provider system 130 provides one or more applications to the user computing systems 110a-110n, such as an ecommerce application or a Web page by way of example only, although other numbers and types of systems which provide other numbers and types of applications can be used. Application provider system 130 preferably includes a central processing unit (CPU) or processor 132, a memory 134, and application server 136, a database 138, and an interface 140 which are coupled together by a bus or other link 142, although other numbers and types of each of the components and other configurations and locations for the components can be used.

Processor 132 in application provider system 130 executes a program of stored instructions for one or more aspects of the present invention as described herein, including for storing data in a centralized location, specifically, database 138. Memory 134 stores these programmed instructions for one or more aspects of the present invention as described herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used for the memory in the management server system. Interface 140 in application provider system 130 is used to operatively couple and communicate between application provider system 130 and user computing systems 110a-110n and service provider systems 150a-150n via communications network 102, although other types and numbers of connections and other configurations and other types of communication systems could be used. In a preferred embodiment, communication network 102 utilizes TCP/IP over Ethernet and uses industry-standard protocols including SOAP, XML, LDAP, and SNMP, although other types and numbers of communication systems, such as a direct connection, a local area network, a wide area network, modems and phone lines, e-mails, and/or wireless communication technology each having their own communications protocols, could be used.

Each of user computing systems 110a-110n enable a user to utilize an application from application provider system 130, such as the ecommerce application by way of example only, although one or more of the user computing systems 110a-110n could utilize other applications and could provide a wide variety of other functions for the user. Each of user computing systems 110a-110n preferably includes a central processing unit (CPU) or processor 112, a memory 114, a user input device 116, a display 118, and an interface 120, which are coupled together by a bus or other link 122. However, user computing systems 110a-110n can comprise other numbers and types of components and systems in other configurations. In addition, any number of user computing systems can be connected to communications network 102. Processor 112 executes a program of stored instructions for one or more aspects of the present invention as described and illustrated herein, including the process for storing centralized data with an application, although the processor 112 could execute other types of programmed instructions.

Memory 114 stores these programmed instructions for one or more aspects of the present invention as described herein, including the process for storing centralized data in database 138 with an application, although some or all of the programmed instructions could be stored and/or executed elsewhere. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to one or more processors, can be used for the memory 114.

User input device 116 is used to input selections, such as user data including name, address, credit card information, frequent flyer information, appointments, relevant personal dates, i.e. birthdays, anniversary, etc., and other personal data and to interact with application provider system 130 and store data in database 138. In addition, user input device 116 could be used to input other types of data and interact with other elements. User input device 116 preferably comprises a computer keyboard and/or a computer mouse, although other types and numbers of user input devices 116 can be used.

Display 118 is used to show data and information to the user, such as the application being utilized and one or more centralized data storage features, although other types of data and information could be displayed and other manners of providing notification can be used, such as via email, page, SMS, and Web. Display 118 comprises a computer display screen, such as a CRT or LCD screen by way of example only, although other types and numbers of displays could be used.

Interface system 120 is used to operatively couple and communicate between user computing systems 110a-110n, application provider system 130, and service provider systems 150a-150n via communications system 102, although other types and numbers of connections and other configurations and other types of communication systems could be used.

Each of service provider systems 150a-150n provides one or more transaction options, such as a good or service which may be provided for free or for a fee, although one or more of the service provider systems 150a-150n could provide other goods or services and could have other functions and other types and numbers of systems could be used. Each of the service provider systems 150a-150n includes a central processing unit (CPU) or processor 152, a memory 154, an application server 156, a database 158, and an interface 160, which are coupled together by a bus or other link 162, although other numbers and types of each of the components and other configurations and locations for the components can be used.

Processor 152 in each of the service provider systems 150a-150n executes a program of stored instructions for one or more aspects of the present invention as described herein, including for storing data in a centralized location. Memory 154 stores these programmed instructions for one or more aspects of the present invention as described herein, although some or all of the programmed instructions could be stored and/or executed elsewhere. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to the processor, can be used for the memory in the management server system. Interface 160 in each of service provider systems 150a-150n is used to operatively couple and communicate between service provider systems 150a-150n, application provider system 130, and user computing systems 110a-110n via communications system 102, although other types and numbers of connections and other configurations and other types of communication systems could be used. Service provider systems 150a-150n also include an application server 156 for providing the application to application provider system 130, which then provides the application to user computing systems 110a-110n.

Although an example of embodiments utilizing application provider system 130, user computing systems 110a-110n, and service provider systems 150a-150n are described and illustrated herein, each of application provider system 130, user computing systems 110a-110n, and service provider systems 150a-150n of the present invention could be implemented on any suitable computer system or computing device. It is to be understood that the devices and systems of the exemplary embodiments are for exemplary purposes, as many variations of the specific hardware and software used to implement the exemplary embodiments are possible, as will be appreciated by those skilled in the relevant art(s).

Furthermore, each of the systems of the present invention may be conveniently implemented using one or more general purpose computer systems, microprocessors, digital signal processors, micro-controllers, and the like, programmed according to the teachings of the present invention as described and illustrated herein, as will be appreciated by those skilled in the computer and software arts.

In addition, two or more computing systems or devices can be substituted for any one of the systems in any embodiment of the present invention. Accordingly, principles and advantages of distributed processing, such as redundancy, replication, and the like, also can be implemented, as desired, to increase the robustness and performance of the devices and systems of the exemplary embodiments. The present invention may also be implemented on computer system or systems that extend across any network using any suitable interface mechanisms and communications technologies including, for example telecommunications in any suitable form (e.g., voice, modem, and the like), wireless communications media, wireless communications networks, cellular communications networks, G3 communications networks, Public Switched Telephone Network (PSTNs), Packet Data Networks (PDNs), the Internet, intranets, a combination thereof, and the like.

The present invention may also be embodied as a computer readable medium having instructions stored thereon for centralized data storage as described herein, which when executed by a processor, cause the processor to carry out the steps necessary to implement the methods of the present invention as described and illustrated herein.

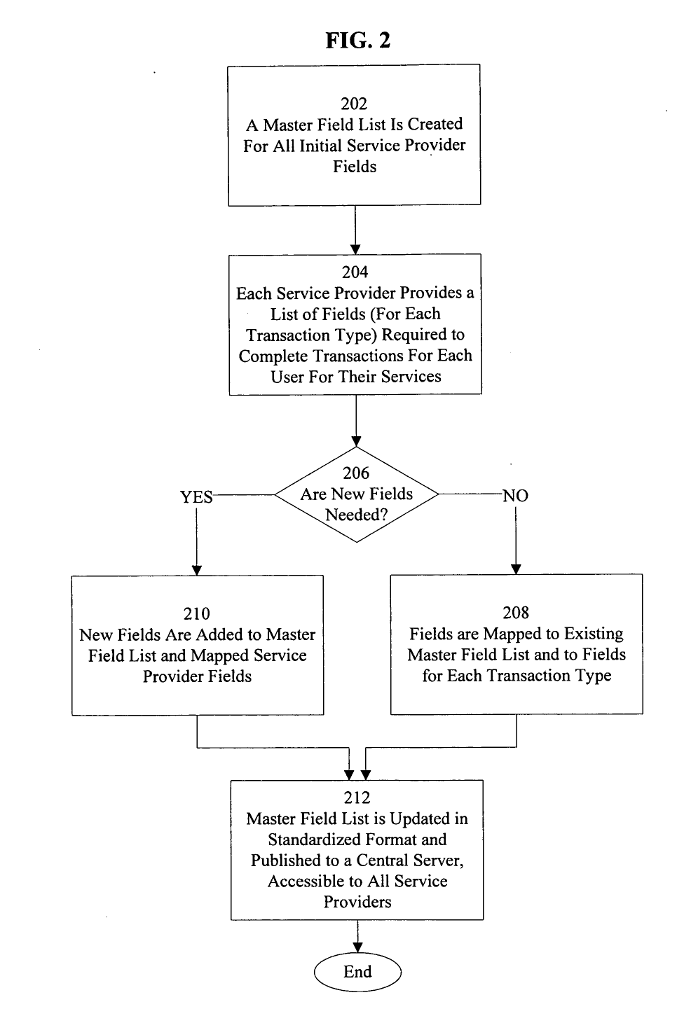

FIG. 2 is a flow chart describing an exemplary method of the invention related to a centralized database. In step 202, a master field list is created for all initial service provider fields on application provider system 130 (See FIG. 1). The master field list is a comprehensive list of all data fields collectively needed for all existing applications and services for service provider systems 150a-150n. In step 204, application provider system 130 receives a list of fields from at least one of a new service provider system 150a-150n that are required to complete each transaction for their services and an existing service provider system 150a-150n that are required to complete a new transaction. Each service provider system and/or transaction type may have different data fields that are required. In step 206, application provider system 130 scans the fields to determine if new fields are necessary. If additional fields are not necessary, then the No branch is taken to step 208. If additional fields are needed which have not yet been previously stored in the master field list, then the Yes branch is taken to step 210 where the fields are added to the master field list and mapped to the fields the service provider system uses.

In step 210, new fields are required, they will be provided by the service provider system 150a-150n, and will be stored by the application provider system 130. By way of example only, these fields can be mailing address, social security number, credit card information, credit information, although other fields may be used.

In step 212, the master field list is updated in standardized format and published to the application provider system 130, to be retrieved by service provider systems 150a-150n.

Although an example of embodiments of the application provider system 130, the user computing systems 110a-110n, and the service provider systems 150a-150n are described and illustrated herein, each of application provider system 130, user computing systems 110a-110n, and service provider systems 150a-150n of the present invention could be implemented on any suitable computer system or computing device. It is to be understood that the devices and systems of the exemplary embodiments are for exemplary purposes, as many variations of the specific hardware and software used to implement the exemplary embodiments are possible, as will be appreciated by those skilled in the relevant art(s).

Furthermore, each of the systems of the present invention may be conveniently implemented using one or more general purpose computer systems, microprocessors, digital signal processors, micro-controllers, and the like, programmed according to the teachings of the present invention as described and illustrated herein, as will be appreciated by those skilled in the computer and software arts.

In addition, two or more computing systems or devices can be substituted for any one of the systems in any embodiment of the present invention. Accordingly, principles and advantages of distributed processing, such as redundancy, replication, and the like, also can be implemented, as desired, to increase the robustness and performance of the devices and systems of the exemplary embodiments. The present invention may also be implemented on computer system or systems that extend across any network using any suitable interface mechanisms and communications technologies including, for example telecommunications in any suitable form (e.g., voice, modem, and the like), wireless communications media, wireless communications networks, cellular communications networks, G3 communications networks, Public Switched Telephone Network (PSTNs), Packet Data Networks (PDNs), the Internet, intranets, a combination thereof, and the like.

The present invention may also be embodied as a computer readable medium having instructions stored thereon for central data store as described herein, which when executed by a processor, cause the processor to carry out the steps necessary to implement the methods of the present invention as described and illustrated herein.

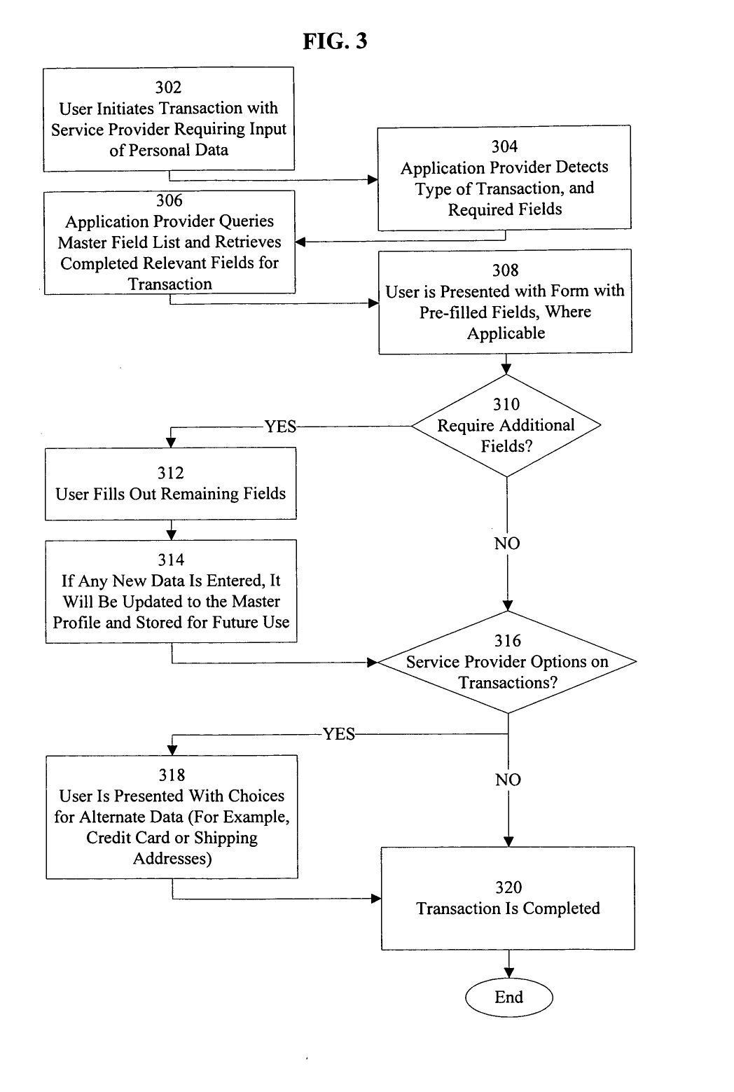

FIG. 3 is a flow chart describing an exemplary method of the invention related to a transaction carried out within the system of the invention. In step 302, application provider system 130 determines if the user initiated transaction will require input of personal data to complete the transaction. In step 304, application provider system 130 detects the type of transaction, and the fields required to complete the specified transaction type. In step 306, application provider system 130 queries database 138 of application provider system 130 and the master field list and retrieves the relevant fields for the given transaction and the existing stored data for those relevant fields.

In step 308, the user of user computing systems 110a-110n is optionally presented with a form with pre-filled fields where applicable by application provider system 130. Depending on the characteristics of the transaction, it may be preferred that the user not be presented with the stored data for confirmation. For example, this may be desirable for recurring transactions that are done frequently. In step 310, if the user does not need to enter additional fields as determined by service provider system 150a-150n, then the No branch is taken to step 316. If the user is required to enter additional fields as determined by service provider system 150a-150n, then the Yes branch is taken to step 312.

In step 312, the user of user computing system 110a-110n fills out the remaining fields using user input device 116 into the fields shown on display 118, although other manners for entering the data can be used, by way of example only, having the data auto-populated from data stored and retrieved from other sources, although other methods can be used. In step 314, the new personal information entered will be updated to the master profile and stored by application provider system 130 for future use.

In step 316, service provider system 150a-150n will determine if one of user computing systems 110a-110n can have the option of choosing alternate options, by way of example only, such as alternate credit card numbers or shipping addresses, although other options may be used. If service provider system 150a-150n determines there are no user choices to be determined, then the No branch is taken to step 320. If so, the Yes branch is taken to step 318, at which point the user is presented with an opportunity to input the alternate data.

Next, in step 320, the transaction is completed by service provider system 150a-150n, and a confirmation is sent to the user of user computing system 110a-110n.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for completing a transaction using user-specific information stored in a centralized database, the method comprising:
receiving a request from a user of a user computing system to initiate a transaction, wherein the transaction requires user-specific information in at least one associated field to complete the transaction;
receiving a request from a service provider system for the user-specific information;
providing the service provider system with the user-specific information when the user-specific information is stored in the centralized database;
requesting the user-specific information from the user computing system when the user-specific information is not stored in the centralized database;
receiving the user-specific information from the user computing system when the user-specific information is not stored in the centralized database; and
storing the user-specific information received from user computing system in the centralized database when the user-specific information is not stored in the centralized database.

2. The method of claim 1, further comprising identifying the user-specific information required for the transaction.

3. The method of claim 1, wherein a user provides the user-specific information not stored in the centralized database via the user computing system.

4. The method of claim 1, wherein the user-specific information sent to the service provider system is limited to only the user-specific information needed to complete the current transaction.

5. The method of claim 4, wherein a user is notified that user-specific information data is being transferred to the service provider system to protect their privacy and data security.

6. The method of claim 1, further comprising publishing the centralized database to a central server on a network after the user-specific information is received from the user computing system and stored in the centralized database.

7. The method of claim 1, further comprising a master list of all fields stored in the centralized database.

8. The method of claim 7, wherein the service provider system is operable to map all existing fields to the master list.

9. The method of claim 7, wherein the master list is in a standardized format.

10. The method of claim 9, wherein the standardized format is XML.

11. The method of claim 1, wherein the service provider system completes the transaction without receiving any user-specific information from the user computing system when all of the needed user-specific information is already stored in the centralized database.

12. The method of claim 11, wherein the transaction is completed without providing any of the user-specific information to the user computing system.

13. The method of claim 1, wherein a user of the user computing system chooses to have the transaction completed without receiving any user-specific information from the application provider system when all of the needed user-specific information is already stored in the centralized database.

14. A computer readable medium having stored thereon instructions for storing user-specific information in a centralized database comprising machine executable code which when executed by at least one processor, causes the processor to perform steps comprising:
receiving a request from a user of a user computing system to initiate a transaction, wherein the transaction requires user-specific information in at least one associated field to complete the transaction;
receiving a request from a service provider system for the user-specific information;
providing the service provider system with the user-specific information when the user-specific information is stored in the centralized database;
requesting the user-specific information from the user computing system when the user-specific information is not stored in the centralized database;
receiving the user-specific information from the user computing system when the user-specific information is not stored in the centralized database; and
storing the user-specific information received from user computing system in the centralized database when the user-specific information is not stored in the centralized database.

15. The computer readable medium of claim 14, further comprising machine executable code which when executed by at least one processor, causes the processor to perform a step of identifying the user-specific information required for the transaction.

16. The computer readable medium of claim 14, wherein a user provides the user-specific information not stored in the centralized database via the user computing system.

17. The computer readable medium of claim 14, wherein the user-specific information sent to the service provider system is limited to only the user-specific information needed to complete the current transaction.

18. The computer readable medium of claim 17, wherein a user is notified that user-specific information data is being transferred to the service provider system to protect their privacy and data security.

19. The computer readable medium of claim 14, further comprising machine executable code which when executed by at least one processor, causes the processor to perform a step of publishing the centralized database to a central server on a network after the user-specific information is received from the user computing system and stored in the centralized database.

20. The computer readable medium of claim 14, further comprising a master list of all fields stored in the centralized database.

21. The computer readable medium of claim 20, wherein the service provider system is operable to map all existing fields to the master list.

22. The computer readable medium of claim 20, wherein the master list is in a standardized format.

23. The computer readable medium of claim 22, wherein the standardized format is XML.

24. The computer readable medium of claim 14, wherein the service provider system completes the transaction without receiving any user-specific information from the user computing system when all of the needed user-specific information is already stored in the centralized database.

25. The computer readable medium of claim 24, wherein the transaction is completed without providing any of the user-specific information to the user computing system.

26. The computer readable medium of claim 14, wherein a user of the user computing system chooses to have the transaction completed without receiving any user-specific information from the application provider system when all of the needed user-specific information is already stored in the centralized database.

27. A system for storing user-specific information in a centralized database, the system comprising:
a user computing system operable to initiate a transaction, wherein the transaction requires user-specific information in at least one associated field to complete the transaction;
an application provider system comprising a centralized database operable to store user-specific information associated with at least one field; and
a service provider system operable to request user-specific information from the application provider system;
wherein the application provider system provides the user-specific information to the service provider system when the user-specific information is stored in the centralized database of the application provider system,
wherein the application provider system requests the user-specific information from the user computing system when the user-specific information is not stored in the centralized database;
wherein the application provider system receives the user-specific information from the user computing system when the user-specific information is not stored in the centralized database, and wherein the application provider system stores the user-specific information in the centralized database when the user-specific information is not stored in the centralized database.

28. The system of claim 27, wherein the user-specific information required for the transaction is identified.

29. The system of claim 27, wherein a user provides the user-specific information not stored in the centralized database via the user computing system.

30. The system of claim 27, wherein the user-specific information sent to the service provider system is limited to only the user-specific information needed to complete the current transaction.

31. The system of claim 30, wherein a user is notified that user-specific information data is being transferred to the service provider system to protect their privacy and data security.

32. The system of claim 27, wherein the centralized database is published to a central server on a network after the user-specific information is received from the user computing system and stored in the centralized database.

33. The system of claim 27, further comprising a master list of all fields stored in the centralized database.

34. The system of claim 33, wherein the service provider system is operable to map all existing fields to the master list.

35. The system of claim 33, wherein the master list is in a standardized format.

36. The system of claim 35, wherein the standardized format is XML.

37. The system of claim 27, wherein the service provider system completes the transaction without receiving any user-specific information from the user computing system when all of the needed user-specific information is already stored in the centralized database.

38. The system of claim 37, wherein the transaction is completed without providing any of the user-specific information to the user computing system.

39. The system of claim 27, wherein a user of the user computing system chooses to have the transaction completed without receiving any user-specific information from the application provider system when all of the needed user-specific information is already stored in the centralized database.
